(19) United States
(12) Patent Application Publication
(10) Pub. No.: US 2022/0194259 A1
(43) Pub. Date: Jun. 23, 2022

(54) INFORMATION PROCESSING APPARATUS, INFORMATION PROCESSING SYSTEM, AND PROGRAM

(71) Applicant: TOYOTA JIDOSHA KABUSHIKI KAISHA, Toyota-shi (JP)

(72) Inventors: Masato EHARA, Gotemba-shi (JP); Kazuhiro SHIMIZU, Sunto-gun (JP); Satoshi TANABE, Mishima-shi (JP); Nanae TAKADA, Susono-shi (JP); Naohiro SEO, Sunto-gun (JP)

(73) Assignee: TOYOTA JIDOSHA KABUSHIKI KAISHA, Toyota-shi (JP)

(21) Appl. No.: 17/496,851

(22) Filed: Oct. 8, 2021

(30) Foreign Application Priority Data
Dec. 17, 2020 (JP) 2020-208940

(51) Int. Cl. B60L 58/12; B60L 53/65

(52) U.S. Cl. CPC B60L 58/12; B60L 53/65; B60L 2260/32; B60L 2200/40; B60Y 2200/40

(57) ABSTRACT

An information processing device includes a processor having hardware. The processor is configured to create, upon acquiring a charging signal indicating that an electric moving vehicle autonomously moving by power stored in a battery requires charging of the battery, or determining that the charging is required, based on a predetermined task additionally set to the electric moving vehicle, schedule information including a travel schedule that enables the electric moving vehicle to travel to a charging station where the battery is to be charged and to perform the task, and output the schedule information to the electric moving vehicle.

### BACKGROUND

### 1. Technical Field

The present disclosure relates to an information processing apparatus, an information processing system, and a program.

### 2. Description of Related Art

Japanese Unexamined Patent Application Publication No. 2003-186539 describes a mobile robot which is provided with a battery and, when a charging level of the battery is equal to or lower than a predetermined level, autonomously returns to a charging station to charge the battery. The mobile robot is provided with a solar cell to charge the battery without returning to the charging station when the charging level of the battery is higher than the predetermined level.

### SUMMARY

There has been a demand for a technology by which a moving vehicle driven by electric energy can be effectively used while the moving vehicle travels to and returns from a charging location.

The present disclosure is to provide an information processing device, an information processing system, and a program, each of which is capable of effectively using a moving vehicle driven by electric energy while the moving vehicle travels to and returns from a charging station.

The information processing device according to the present disclosure includes a processor having hardware. The processor is configured to create, upon acquiring a charging signal indicating that an electric moving vehicle autonomously moving by power stored in a battery requires charging of the battery, or determining that the charging is required, based on a predetermined task additionally set to the electric moving vehicle, schedule information including a travel schedule that enables the electric moving vehicle to travel to a charging station where the battery is to be charged and to perform the task, and output the schedule information to the electric moving vehicle.

The information processing system according to the present disclosure includes a first device and a second device. The first device includes a task unit configured to execute a predetermined task that is additionally set, a rechargeable battery, a first processor that has hardware and is configured to acquire task information including information on the task and schedule information on traveling, and to output an instruction signal for autonomous travel based on the schedule information. The second device includes a second processor that has hardware and is configured to create, upon acquiring a charging signal indicating that the battery requires charging in the first device, or determining that the charging is required, based on the task preset by the task unit, the schedule information including a travel schedule that enables the first device to travel to a charging station where the battery is to be charged and enables the task unit to perform the task, and output the schedule information to the first device.

The program according to the present disclosure causes a processor having hardware to execute creating, upon acquiring a charging signal indicating that an electric moving vehicle autonomously moving by power stored in a battery requires charging of the battery, or determining that the charging is required, based on a predetermined task additionally set to the electric moving vehicle, schedule information including a travel schedule that enables the electric moving vehicle to travel to a charging station where the battery is to be charged and to perform the task, and outputting the schedule information to the electric moving vehicle.

With the present disclosure, it is possible to effectively use a moving vehicle driven by electric energy while the moving vehicle leaves and returns to a charging location.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a management system according to one embodiment;

FIG. 2 is a block diagram schematically illustrating a configuration of an area management server according to one embodiment;

FIG. 3 is a block diagram schematically illustrating a configuration of a cleaning vehicle according to one embodiment;

FIG. 4 is a block diagram schematically illustrating a configuration of a delivery vehicle according to one embodiment;

FIG. 5 is a block diagram schematically illustrating a configuration of a waste disposal facility according to one embodiment;

FIG. 6 is a block diagram schematically illustrating a configuration of a package processing facility according to one embodiment;

FIG. 7 is a schematic diagram illustrating a charging station according to one embodiment; and

FIG. 8 is a flow chart illustrating a management method according to one embodiment.

### DETAILED DESCRIPTION OF EMBODIMENTS

Hereinafter, one embodiment of the present disclosure will be described with reference to drawings. In all the drawings of the following embodiment, the same reference numbers shall refer to the same or equivalent elements. Further, the present disclosure is not limited to one embodiment described below.

In recent years, a moving vehicle capable of automatic driving in a predetermined area called “a smart city” has been considered. For example, an automatically driven moving vehicle such as an electric vehicle may leave and return to a predetermined charging location in a case where charging is required. In this case, there has been a demand for a technology capable of effectively using a moving vehicle leaving and returning to a predetermined charging location, instead of simply traveling. For example, the moving vehicle capable of automatic driving may collect waste and/or automatically deliver mail and packages within the predetermined area. Therefore, the inventors were able to arrive at an idea of introducing functions of collecting waste, and carrying mail or packages in a moving vehicle driven by electric energy which leaves or returns to a predetermined charging location, in a case where the charging location is close to a drop-off point of waste, mail, or packages. The inventors suggest a method in which a moving vehicle having a collection or carrying functions discards waste at a landfill site or delivers mail or packages to a drop-off point, when traveling to the charging location, as triggered by a state in which charging is required, and stops at the drop-off point for mail or packages to collect and deliver the mail or packages when returning from the charging location. The embodiment described below is based on the suggestion stated above.

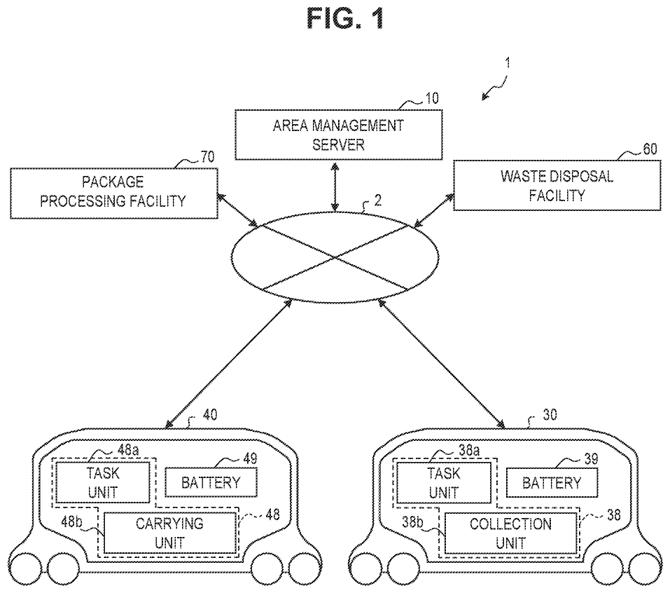

First, a management system to which the information processing device according to one embodiment of the present disclosure is applicable will be described hereinbelow. FIG. 1 is a schematic diagram illustrating a management system 1 according to the present embodiment. As shown in FIG. 1, a management system 1 according to the present embodiment includes an area management server 10, a task vehicle 30 which is provided with a functional unit 38 and a battery 39, in which the functional unit 38 has a collection unit 38b and a task unit 38a, a task vehicle 40 which is provided with a functional unit 48 and a battery 49, in which the functional unit 48 has a task unit 48a and a carrying unit 48b, a waste disposal facility 60, and a package processing facility 70, which can establish communication with each other via a network 2. In the following description, information transmission/reception between the respective components is established via communication units in the components and the network 2. However, the description of respective components will be omitted.

The network 2 is configured by, for example, the Internet or a mobile phone network. The network 2 is, for example, a public communication network such as the Internet, and may include a telephone communication network such as a Wide Area Network (WAN) and a mobile phone, and other communication networks such as a wireless communication network such as Wi-Fi (registered trademark).

Area Management Server

The area management server 10 as a travel management device for the task vehicles 30 and 40 can manage travel of the task vehicles 30 and 40. The area management server 10 as an information processing device can manage waste and packages in a predetermined area such as a smart city. In the present embodiment, various pieces of information (such as vehicle information and travel information) are supplied to the area management server 10 from the respective task vehicles 30 and 40 at predetermined timings. The vehicle information includes, but is not limited to, vehicle identification information and sensor information. The sensor information includes, but is not limited to, remaining energy information on remaining energy, such as a remaining fuel amount and battery charge (SOC: state of charge) of task vehicles 30 and 40, and information on traveling of the task vehicles 30 and 40, such as speed information and acceleration information. The travel information includes, but is not limited to, location information and travel route information of the task vehicles 30 and 40. The area management server 10 is capable of transmitting and receiving waste information as the task information to and from the task vehicle 30, and is also capable of transmitting and receiving delivery information as the task information to and from the task vehicle 40.

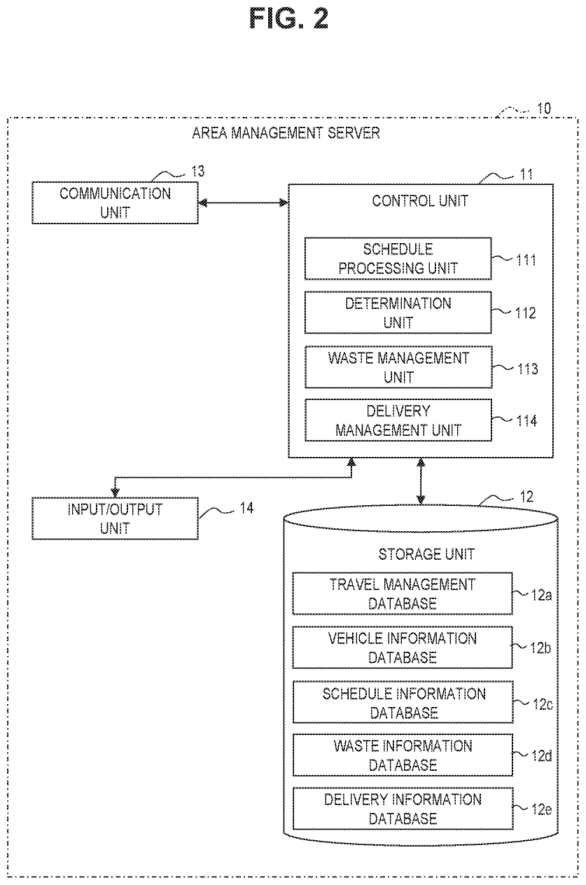

FIG. 2 is a block diagram schematically illustrating a configuration of the area management server 10. As shown in FIG. 2, the area management server 10 as the second device has a general computer configuration capable of communication via the network 2. The area management server 10 includes a control unit 11, a storage unit 12, a communication unit 13, and an input/output unit 14.

The control unit 11 as the second processor having hardware for controlling travel is provided with, in particular, a processor, for example, a central processing unit (CPU), a digital signal processor (DSP) or a field-programmable gate array (FPGA), and a main storage unit, for example, a random access memory (RAM) or a read only memory (ROM).

The storage unit 12 is configured by a storage medium selected from an EPROM (erasable programmable ROM), an HDD (hard disk drive), a removable medium, and the like. Further, examples of the removable medium include a disc recording medium such as a USB (universal serial bus) memory, a CD (compact disc), a DVD (digital versatile disc), and a BD (Blu-ray® disc). The storage unit 12 can store an operating system (OS), various programs, various tables, various databases, and the like.

The control unit 11 loads and executes the program stored in the storage unit 12 into a task area of the main storage unit, and by executing the program, functions of a schedule processing unit 111, a determination unit 112, a waste management unit 113, and a delivery management unit 114 can be implemented. In a case where, as the program, a learning model is used in the schedule processing unit 111, the learning model can be generated by machine learning, for example, deep learning using a neural network with an input/output data set of predetermined input and output parameters as training data. The same applies to the determination unit 112, the waste management unit 113, and the delivery management unit 114. Accordingly, the control unit 11 can implement the functions of the schedule processing unit 111, the determination unit 112, the waste management unit 113, and the delivery management unit 114 using the learning model.

The storage unit 12 stores a travel management database 12a, a vehicle information database 12b, a schedule information database 12c, a waste information database 12d, and a delivery information database 12e in which various types of data are stored so as to be searched. For these databases 12a to 12e, for example, a relational database (RDB) can be employed. In the present embodiment, the database (DB) can be configured by the program of a database management system (DBMS) executed by the processor, which manages the data stored in the storage unit 12.

In the travel management database 12a, the vehicle identification information as the vehicle information is associated with the other pieces of information such as the travel information, which is stored so as to be updated, deleted, and searched. The vehicle information database 12b stores, for example, the sensor information associated with the vehicle identification information in the task vehicles 30 and 40 such that the sensor information can be updated, deleted, and searched. In the schedule information database 12c, information on travel schedules of the task vehicles 30 and 40 (hereinafter referred to as “schedule information”) is associated with the vehicle identification information of the task vehicles 30 and 40, which is stored so as to be updated, deleted, and searched. The waste information database 12d stores waste information acquired from the waste disposal facility 60 such that it can be updated, deleted, and searched. The waste information includes various pieces of information on waste, and a collection location where the task vehicle 30 collects the waste. The delivery information database 12e stores delivery information acquired from the package processing facility 70 such that it can be updated, deleted, and searched. The delivery information includes various pieces of information, such as information on whether there is a package or not, for the package picked up or delivered by the task vehicle 40, information on a package location, and the like.

The vehicle identification information assigned to the respective task vehicles 30 and 40 is stored in the travel management database 12a such that it can be searched. The vehicle identification information includes various pieces of information for identifying the respective task vehicles 30 and 40, and also includes information required for accessing the area management server 10 upon transmitting the information on the task vehicles 30 and 40. The vehicle identification information is also transmitted when the task vehicle 30 transmits various types of information. When the task vehicle 30 transmits predetermined information, such as the travel information, together with the vehicle identification information to the area management server 10, the control unit 11 of the area management server 10 stores the predetermined information associated with the vehicle identification information in the travel management database 12a such that it can be searched.

The communication unit 13 is, for example, a LAN (local area network) interface board or a wireless communication circuit for wireless communication. The LAN interface board and the wireless communication circuit are connected to the network 2, such as the Internet, which is a public communication network. The communication unit 13 can be connected to the network 2 to communicate with the task vehicles 30 and 40, the waste disposal facility 60, and the package processing facility 70. The communication unit 13 can receive the vehicle identification information and the vehicle information, which are unique to the task vehicles 30 and 40, from the task vehicles 30 and 40, and can also transmit various instruction signals and confirmation signals to the task vehicles 30 and 40. The communication unit 13 can transmit and receive the waste information to and from the waste disposal facility 60. The communication unit 13 can transmit and receive the delivery information to and from the package processing facility 70.

The input/output unit 14 may be configured by, for example, a touchscreen display or a speaker microphone. The input/output unit 14, as an output unit, is configured to send, to the outside, a notification on the predetermined information by displaying characters and figures on a screen of a display, such as a liquid crystal display, an organic EL display, or a plasma display, or alternatively, by outputting sound from a speaker, as controlled by the control unit 11. The input/output unit 14 includes a printer that outputs by printing the predetermined information on a printing paper or the like. Various pieces of information stored in the storage unit 12 can be confirmed, for example, on the display of the input/output unit 14 installed in, for example, a predetermined office. The input/output unit 14, as an input unit, is configured by, for example, a touchscreen keyboard which is incorporated inside a keyboard or the input/output unit 14 so as to detect a touch operation on a display panel, or alternatively, a sound input device which enables calling to the outside. By inputting the predetermined information from the input/output unit 14 of the area management server 10, it is possible to remotely manage the travel of the task vehicles 30 and 40, thus travel of the task vehicles 30 and 40, which are self-driving vehicles capable of autonomous travel, can be easily managed.

Cleaning Vehicle

The task vehicle 30, which is a cleaning vehicle, i.e., the first device, is a moving vehicle capable of performing various predetermined tasks set in advance, by additionally having separate functions different from vehicle-specific functions, such as a collection, transportation, and disposal of waste. As the moving vehicle, a self-driving vehicle which is configured to enable autonomous travel according to a travel command issued by the area management server 10 or a predetermined program can be employed.

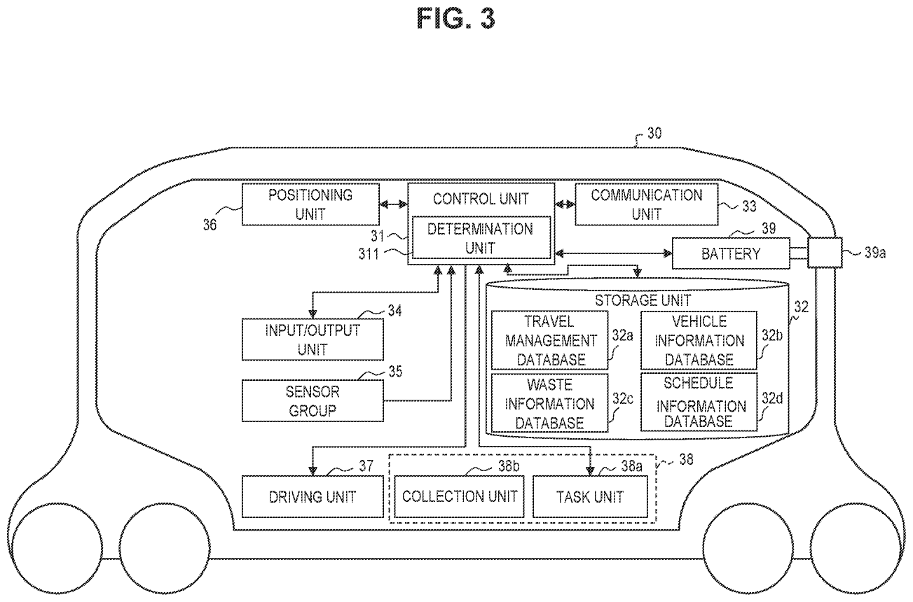

FIG. 3 is a block diagram schematically illustrating a configuration of the task vehicle 30. As shown in FIG. 3, the task vehicle 30 includes a control unit 31, a storage unit 32, a communication unit 33, an input/output unit 34, a sensor group 35, a positioning unit 36, a drive unit 37, a functional unit 38, which has a task unit 38a and a collection unit 38b, and a battery 39 connected to a connector 39a. As the task vehicle 30, for example, a moving vehicle with, for example, an automatic cleaning robot, can be employed. The control unit 31, the storage unit 32, the communication unit 33, and the input/output unit 34 have the same physical and functional configurations as the control unit 11, the storage unit 12, the communication unit 13, and the input/output unit 14, respectively.

The control unit 31 as the first processor having hardware comprehensively controls the operations of various components mounted on the task vehicle 30. The control unit 31 can implement a function of a determination unit 311 by reading out the program stored in the storage unit 32. The storage unit 32 can store a travel information database 32a, a vehicle information database 32b, a waste information database 32c, and a schedule information database 32d. The travel information database 32a stores various data including the travel information provided by the area management server 10 such that it can be updated, deleted, and searched. Various pieces of information including, for example, a battery charge, remaining fuel amount, and a current location, are stored in the vehicle information database 32b so as to be updated, deleted, and searched. The waste information database 32c stores various pieces of information on waste and a collection location where the task unit 38a of the task vehicle 30 collects the waste, such that they can be updated, deleted, and searched. The schedule information database 32d stores the schedule information on traveling of the corresponding task vehicle 30 such that it can be updated, deleted, and searched.

The communication unit 33 establishes communication with the area management server 10 by wireless communication via the network 2. The input/output unit 34 as an output unit is configured such that the predetermined information can be announced to the outside. The input/output unit 34 as an input unit is configured such that, for example, a user can input the predetermined information to the control unit 31.

The sensor group 35 may include sensors related to traveling of the task vehicle 30 (e.g. a vehicle speed sensor, an acceleration sensor, and a fuel sensor), in-vehicle sensors capable of detecting various situations in, for example, a vehicle compartment, or an image capture unit configured by an image sensor or an image capture element (e.g. CMOS or CCD camera) that can capture the inside of the task vehicle 30. The sensor information including the image information detected by the various sensors constituting the sensor group 35 is outputted to the control unit 31 via a vehicle information network (control area network, CAN) configured by transmission lines connected to the various sensors. In the present embodiment, the sensor information collected by the sensor group 35 constitutes a portion of the vehicle information.

The positioning unit 36 as a location information acquisition unit receives radio waves from a global positioning system (GPS) satellite so as to detect a location of the task vehicle 30. The detected location is stored such that it can be searched in the vehicle information database 32b as location information within the vehicle information. As a method of detecting the location of the task vehicle 30, combining LiDAR (Laser Imaging Detection and Ranging, or Light Detection and Ranging) and a three-dimensional digital map may be adopted. Further, the location information may be included in the travel information, and thus the location information of the task vehicle 30 detected by the positioning unit 36 may be stored in the travel information database 32a.

The drive unit 37 is a drive unit for traveling the task vehicle 30. In particular, the task vehicle 30 includes a motor as a drive source. The motor is driven by electrical energy supplied from the battery 39. The task vehicle 30 includes a drive transmission mechanism for transmitting the driving force of the motor, drive wheels for running, and the like.

The functional unit 38 has the task unit 38a and the collection unit 38b. The task unit 38a of the functional unit 38 is a mechanism for a collection task, which is collecting waste from a predetermined location or on a road, and storing the waste in the collection unit 38b. The collection unit 38b of the functional unit 38 is a storage area for temporarily storing the waste collected by the task unit 38a. The task unit 38a is capable of performing a disposal task, which is transporting the waste collected in the collection unit 38b to a predetermined waste disposal facility 60 and disposing the waste in the landfill site 65.

Delivery Vehicle

The task vehicle 40, which is a delivery vehicle i.e., the first device, is a moving vehicle capable of performing various predetermined tasks set in advance, by having additional functions such as a collection, transportation, and delivery of packages. As the moving vehicle, a self-driving vehicle which is configured to enable autonomous travel according to a travel command issued by the area management server 10 or a predetermined program can be employed.

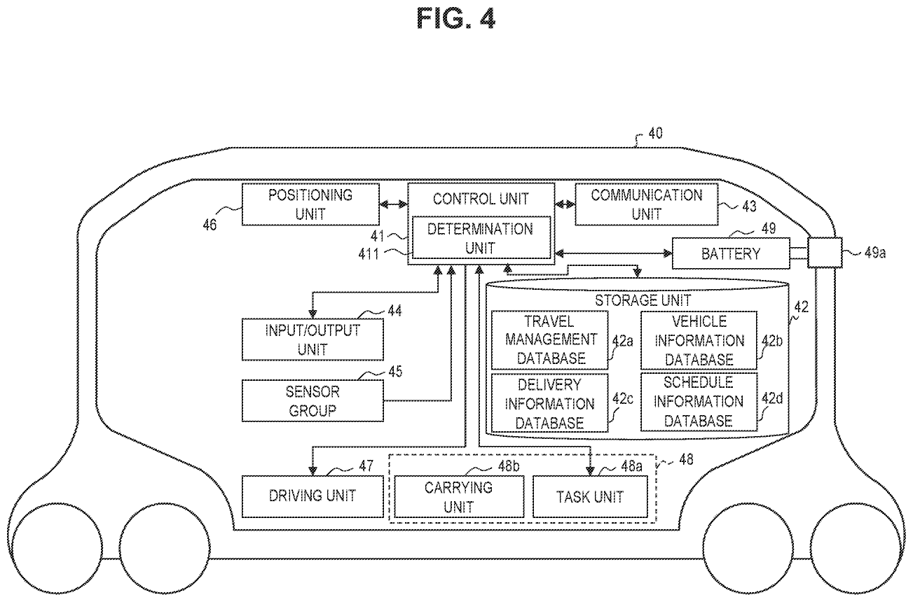

FIG. 4 is a block diagram schematically illustrating a configuration of the task vehicle 40. As shown in FIG. 4, the task vehicle 40 includes a control unit 41, which corresponds to the first processor having hardware and includes a determination unit 411, a storage unit 42, a communication unit 43, an input/output unit 44, a sensor group 45, a positioning unit 46, a drive unit 47, a functional unit 48, which has a carrying unit 48b and a task unit 48a, and a battery 49 connected to a connector 49a. As the task vehicle 40, a moving vehicle with, for example, an automatic pick-up/delivery robot can be employed. The control unit 41, the determination unit 411, the storage unit 42, the communication unit 43, the input/output unit 44, the sensor group 45, the positioning unit 46, the drive unit 47, the battery 49, and the connector 49a have physically and functionally the same configuration as the control unit 31, the determination unit 311, the storage unit 32, the communication unit 33, the input/output unit 34, the sensor group 35, the positioning unit 36, the drive unit 37, the battery 39, and the connector 39a in the task vehicle 30, respectively.

The functional unit 48 has the task unit 48a and the carrying unit 48b. The task unit 48a of the functional unit 48 is capable of performing a collection task, which is collecting packages or mail (hereinafter collectively referred to as “package(s)”) from a postbox such as a mailbox in the predetermined area, a pick-up/delivery facility, a dwelling facility, and storing same in the carrying unit 48b. The carrying unit 48b of the functional unit 48 is a storage area for temporarily storing the packages collected by the task unit 48a. Further, as the second task, the task unit 48a is capable of performing a delivery task, which is transporting the packages received from a predetermined package processing facility 70 and carried by the carrying unit 48b to a delivery destination or a dwelling facility within the predetermined area, and then delivering the packages. The second task is a task preset by a separate function which is additionally included and is different from the vehicle-specific function.

The storage unit 42 can store a travel information database 42a, a vehicle information database 42b, a delivery information database 42c, and a schedule information database 42d. The travel information database 42a, the vehicle information database 42b, and the schedule information database 42d are the same as the travel information database 32a, the vehicle information database 32b, and the schedule information database 32d in the storage unit 32 of the task vehicle 30, respectively. The delivery information database 42c stores various pieces of information on the packages picked up and delivered by the functional unit 48 of the task vehicle 40, such that they can be updated, deleted, and searched.

Waste Disposal Facility

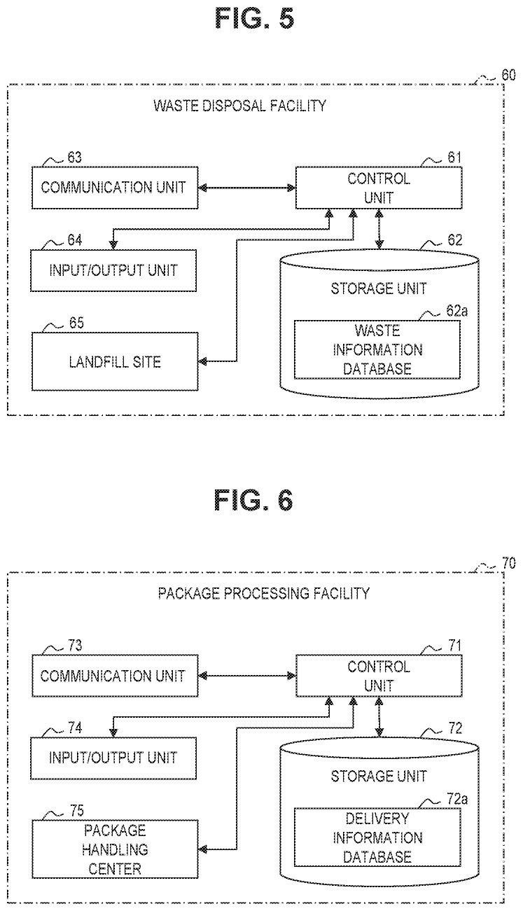

The waste disposal facility 60 is a facility that collects and incinerates the collected waste in the predetermined area such as the smart city. FIG. 5 is a block diagram schematically illustrating a configuration of the waste disposal facility 60. As shown in FIG. 5, the waste disposal facility 60 has a general computer configuration capable of communication via the network 2, and includes a control unit 61, a storage unit 62, a communication unit 63, and an input/output unit 64. The waste disposal facility 60 can transmit and receive the waste information to and from the area management server 10 via the communication unit 63 and the network 2.

The control unit 61, the storage unit 62, the communication unit 63, and the input/output unit 64 have the same physical and functional configurations as the control unit 11, the storage unit 12, the communication unit 13, and the input/output unit 14, respectively. The storage unit 62 can store various programs, various tables, various databases, and the like, such as an operating system and a waste information database 62a.

The waste disposal facility 60 includes a landfill site 65. The landfill site 65 is a site for pretreatment of the waste collected by the task vehicle 30, which is also called a dump or a dumping ground. The task vehicle 30 transports the waste collected in the collection unit 38b to the landfill site 65 and then disposes of the waste by the task unit 38a. The landfill site 65 is provided at a location close to a charging station 50 capable of charging the task vehicle 30. The term “close to” herein is a range of several hundred meters to several kilometers as a distance. Further, the charging station 50 may be installed underground, and in this case, the landfill site 65 is also provided at a location close to the charging station 50 provided underground.

Package Processing Facility

The package processing facility 70 is a facility where packages are collected in the predetermined area such as the smart city, carried outside of the predetermined area, and where packages brought in from outside the predetermined area are temporarily stored so as to be delivered to facilities or dwelling facilities within the predetermined area. FIG. 6 is a block diagram schematically illustrating a configuration of the package processing facility 70. As shown in FIG. 6, the package processing facility 70 has a general computer configuration capable of communication via the network 2, and includes a control unit 71, a storage unit 72, a communication unit 73, and an input/output unit 74. The package processing facility 70 can transmit and receive the delivery information to and from the area management server 10 via the communication unit 73 and the network 2.

The control unit 71, the storage unit 72, the communication unit 73, and the input/output unit 74 have the same physical and functional configurations as the control unit 11, the storage unit 12, the communication unit 13, and the input/output unit 14, respectively. The storage unit 72 can store various programs, various tables, various databases, and the like, such as an operating system and a delivery information database 72a.

The package processing facility 70 includes a package handling center 75. The package handling center 75 is for sortation and processing of the packages collected by the task vehicle 40, and examples thereof include a post office, a fulfillment center, a distribution center, and a cross-dock facility. The task vehicle 40 transports the packages carried by the carrying unit 48b to the package handling center 75, and drops off the packages by the task unit 48a. The package handling center 75 is provided at a location close to a charging station 50 capable of charging the task vehicle 40. The term “close to” herein is a range of several hundred meters to several kilometers as a distance. Further, the charging station 50 may be installed underground, and in this case, the package handling center 75 is also provided at a location close to the charging station 50 provided underground.

Charging Station

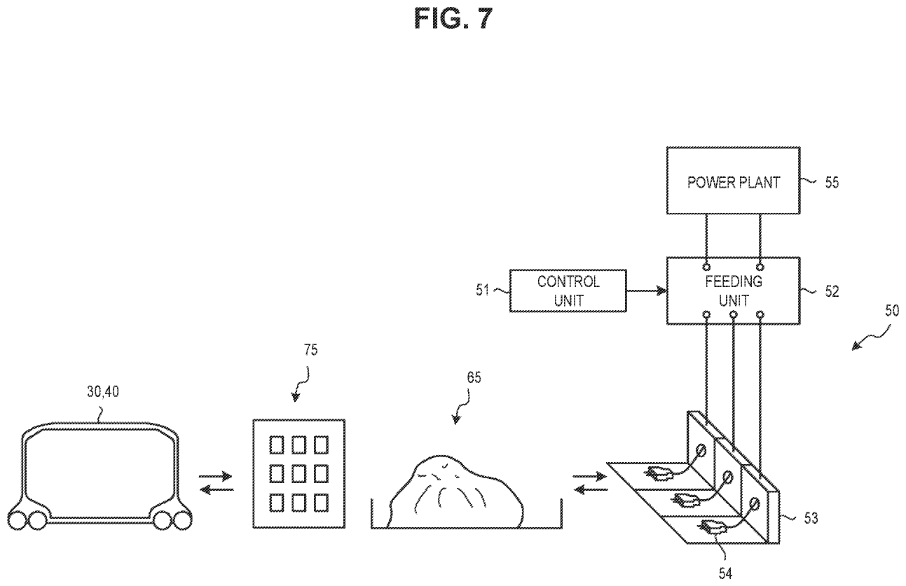

The charging station 50 controlled by the area management server 10 will be described hereinbelow. FIG. 7 is a schematic diagram illustrating the charging station according to one embodiment.

As shown in FIG. 7, the charging station 50 includes a charger 53 including a control unit 51, a feeding unit 52, and a plug 54. Electric power is supplied to the feeding unit 52 of the charging station 50 from a power plant 55 that generates electricity by a supply wire. The plug 54 provided in the charger 53 is electrically connected to the feeding unit 52 and is configured to be connectable to the connectors 39a and 49a of the task vehicles 30 and 40, respectively. The charging station 50 is configured to be able to supply electric power to the task vehicles 30 and 40. The charging station 50 is provided at a location close to the landfill site 65 or the package handling center 75. The term “close to” herein is a range of several hundred meters to several kilometers as a distance. Further, the charging station 50 may be provided underground.

The control unit 51 may be the control unit 11 of the area management server 10, or an independent control unit. The control unit 51 is configured to input SOC information from the respective task vehicles 30 and 40. In a case where the feeding unit 52 controlled by the control unit 51 supplies power to, for example, the task vehicles 30 and 40, it is possible to supply the electric power with an amount corresponding to the SOC of the task vehicle 30 or 40, e.g., a power amount proportional to the reciprocal of the SOC.

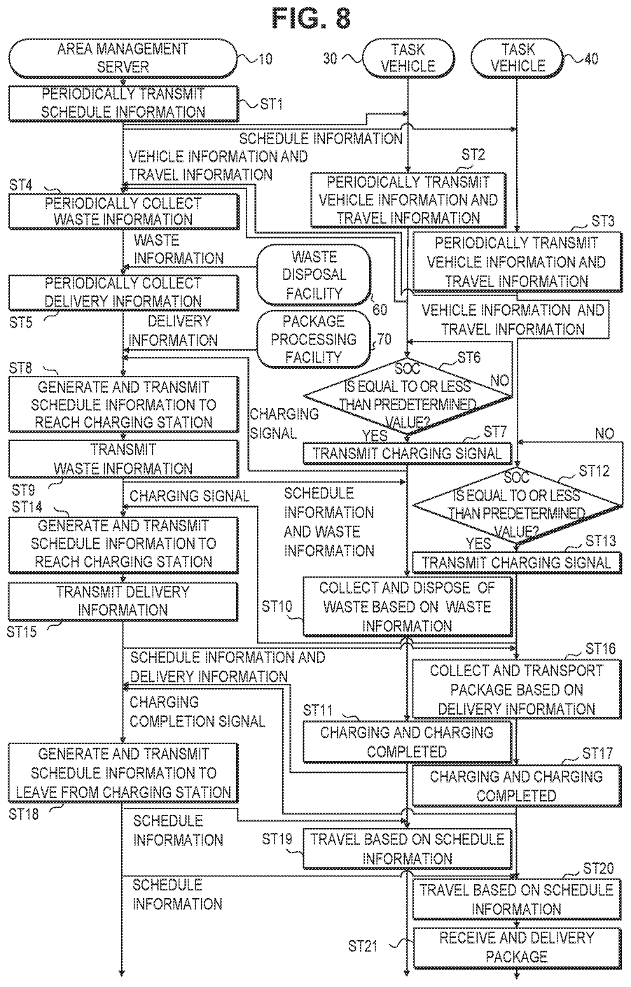

A management for a task vehicle according to the present embodiment will be described hereinbelow. FIG. 8 is a flow chart illustrating a management method according to the present embodiment. In the following description, information is transmitted and received via the network 2, but descriptions thereof will be omitted. Further, in a case where information is transmitted/received to/from the task vehicles 30 and 40, the information to be transmitted/received is also transmitted/received in association with the identification information for individually identifying the task vehicles 30 and 40. However, descriptions thereof will also be omitted. Moreover, the flow chart shown in FIG. 8 shows a process related to a case where the task vehicles 30 and 40 are charged once. The flowchart shown in FIG. 8 is executed for each charging of the task vehicles 30 and 40.

As shown in FIG. 8, in step ST1, the schedule processing unit 111 of the control unit 11 in the area management server 10 periodically reads out the schedule information from the schedule information database 12c and transmits it to the task vehicles 30 and 40. The task vehicles 30 and 40 store the received schedule information in the schedule information databases 32d and 42d, respectively. The schedule information is transmitted to the corresponding task vehicles 30 and 40 based on the vehicle identification information of the respective task vehicles 30 and 40. The task vehicles 30 and 40 travel within the predetermined area based on the schedule information acquired. That is, the schedule information includes information such as travel plans and travel diagrams of the task vehicles 30 and 40.

In steps ST2 and ST3, the task vehicles 30 and 40 transmit the vehicle information and the travel information to the area management server 10 periodically or at predetermined timings. The control unit 11 of the area management server 10 that has received the vehicle information and the travel information stores the received travel information in the travel management database 12a, and the received vehicle information in the vehicle information database 12b. Additionally, steps ST2 and ST3 may be executed in reverse order or in parallel.

Moreover, in step ST4, the area management server 10 periodically collects the waste information from the waste disposal facility 60. The control unit 11 stores the received waste information in the waste information database 12d as readable information. The waste information includes information on whether there is waste or not, and information on a location of waste, collected by the waste disposal facility 60. Moreover, the waste information may be collected by the area management server 10 instead of the waste disposal facility 60.

In step ST5, the area management server 10 periodically collects the delivery information from the package processing facility 70. The control unit 11 stores the received delivery information in the delivery information database 12e. The delivery information includes information on whether there is a package or not, and information on a location of the package, collected by the package processing facility 70. Further, the delivery information may be collected by the area management server 10 instead of the package processing facility 70. Steps ST5 and ST6 may be executed in reverse order or in parallel.

In step ST6, the determination unit 311 of the control unit 31 in the task vehicle 30 determines whether the SOC in the vehicle information is equal to or less than a predetermined value. The predetermined value of SOC may be larger than the SOC required to travel from a current location of the task vehicle 30 to the charging location. While the determination unit 311 determines whether the SOC of the battery 39 in the task vehicle 30 is larger than the predetermined value (step ST6: NO), step ST6 is repeatedly executed. In a case where the determination unit 311 determines that the SOC of the battery 39 in the task vehicle 30 is equal to or less than the predetermined value (step ST6: YES), the process proceeds to step ST7. The determination unit 112 of the area management server 10 may execute the determination as to whether the SOC in the vehicle information is equal to or less than the predetermined value. When the process proceeds to step ST7, the control unit 31 of the task vehicle 30 generates a charging signal and transmits the signal to the area management server 10.

When the process proceeds to step ST8, the schedule processing unit 111 of the area management server 10 that has received the charging signal from the task vehicle 30 reads out the current location information of the task vehicle 30 from the travel management database 12a and reads out the schedule information from the schedule information database 12c. The schedule processing unit 111 generates a travel route from the current location of the task vehicle 30 to the charging station 50, updates the schedule information, and stores the updated schedule information in the schedule information database 12c. At this time, the schedule processing unit 111 reads out the waste information from the waste information database 12d, and generates a new travel route such that the route passes through a location at which there is waste based on the travel route of the task vehicle 30. The schedule processing unit 111 transmits the generated schedule information to the task vehicle 30. The control unit 31 of the task vehicle 30 stores the received schedule information in the schedule information databases 32d. When the process proceeds to step ST9, the waste management unit 113 of the control unit 11 transmits, to the task vehicle 30, the waste information corresponding to the travel route of the task vehicle 30. The control unit 31 of the task vehicle 30 stores the received waste information in the waste information database 32c. Steps ST8 and ST9 may be executed in reverse order or in parallel.

When the process proceeds to step ST10, the task vehicle 30 that has acquired the schedule information and the waste information collects the waste on the travel route according to the schedule information, based on the acquired waste information. As shown in FIG. 7, the task vehicle 30 travels to the landfill site 65 according to the schedule information, and disposes of the waste at the landfill site 65.

Subsequently, the process proceeds to step ST11 shown in FIG. 8. The task vehicle 30 travels to the charging station 50 and charges the battery 39. When the charging of the battery 39 in the task vehicle 30 is complete, the control unit 31 of the task vehicle 30 generates a charging completion signal and transmits the signal to the area management server 10.

Meanwhile, the determination unit 411 of the control unit 41 in the task vehicle 40 determines whether the SOC in the vehicle information is equal to or less than a predetermined value in step ST12. The predetermined value of SOC may be larger than the SOC required to travel from a current location of the task vehicle 40 to the charging location. While the determination unit 411 determines whether the SOC of the battery 49 in the task vehicle 40 is larger than the predetermined value (step ST12: NO), step ST12 is repeatedly executed. In a case where the determination unit 411 determines that the SOC of the battery 49 in the task vehicle 40 is equal to or less than the predetermined value (step ST12: YES), the process proceeds to step ST13. The determination unit 112 of the area management server 10 may execute the determination as to whether the SOC in the vehicle information is equal to or less than the predetermined value. When the process proceeds to step ST13, the control unit 41 of the task vehicle 40 generates a charging signal and transmits the signal to the area management server 10.

When the process proceeds to step ST14, the schedule processing unit 111 of the area management server 10 that has received the charging signal from the task vehicle 40 reads out the current location information of the task vehicle 40 from the travel management database 12a and reads out the schedule information from the schedule information database 12c. The schedule processing unit 111 generates a travel route from the current location of the task vehicle 40 to the charging station 50, updates the schedule information, and stores the updated schedule information in the schedule information database 12c. At this time, the schedule processing unit 111 reads out the delivery information from the delivery information database 12e, and generates a new travel route such that the route passes through a location at which the package will be picked up based on the travel route of the task vehicle 40. The schedule processing unit 111 transmits the generated schedule information to the task vehicle 40. The control unit 41 of the task vehicle 40 stores the received schedule information in the schedule information database 42d. When the process proceeds to step ST15, the delivery management unit 114 of the control unit 11 transmits, to the task vehicle 40, the delivery information corresponding to the travel route of the task vehicle 40. The control unit 41 of the task vehicle 40 stores the received delivery information in the delivery information database 42c. Steps ST14 and ST15 may be executed in reverse order or in parallel.

When the process proceeds to step ST16, the task vehicle 40 that has acquired the schedule information and the delivery information collects the package on the travel route according to the schedule information, based on the acquired delivery information. As shown in FIG. 7, the task vehicle 40 travels to the package handling center 75 according to the schedule information, transports and hands over the package to the package handling center 75.

Subsequently, the process proceeds to step ST17 shown in FIG. 8. The task vehicle 40 travels to the charging station 50 and charges the battery 49. When the charging of the battery 49 in the task vehicle 40 is completed, the control unit 41 of the task vehicle 40 generates a charging completion signal and transmits the signal to the area management server 10.

In step ST18, the schedule processing unit 111 of the area management server 10 that has received the charging completion signal generates the schedule information for returning from the charging station 50 and traveling to, for example, the previous location. Any location can be set as a location to which the task vehicle returns from the charging station 50. Information on such a location is included in the schedule information. The schedule processing unit 111 transmits the generated schedule information to the task vehicles 30 and 40, which respectively output the charging completion signal.

When the process proceeds to step ST19, the task vehicle 30 that has received the schedule information from the charging station 50 as the second schedule information stores the received schedule information in the schedule information database 32d. The control unit 31 of the task vehicle 30 travels based on the schedule information read out from the schedule information database 32d.

Further, when the process proceeds to step ST20, the task vehicle 40 that has received the schedule information from the charging station 50 stores the received schedule information in the schedule information database 42d. The control unit 41 of the task vehicle 40 travels based on the schedule information read out from the schedule information database 42d. When the process proceeds to step ST21, the task vehicle 40 travels to the package handling center 75 to receive and store the package in the carrying unit 48b, and then reads out the delivery information from the delivery information database 42c, and delivers the received package while traveling to the location to which it returns, based on the read delivery information. Accordingly, the management process of the task vehicle according to the present embodiment is completed.

According to one embodiment of the present disclosure described above, the task vehicles 30 and 40 that travel within the predetermined area such as the smart city by electric energy can clean and dispose of waste to the landfill site 65, or can collect and transport the packages to the package handling center 75 while traveling to the charging station 50 after it is determined that the charging is required, thus it is possible to effectively use the task vehicle traveling to the charging station 50. Further, since the task vehicle 40 can deliver packages on the travel route while returning to any location from the charging station 50, it is possible to effectively use the task vehicle traveling to and returning from the charging station 50.

Although the embodiment of the present disclosure has been specifically described above, the present disclosure is not limited to the embodiment stated above, and various modifications and combinations of embodiments can be adopted based on the technical idea of the present disclosure. For example, device configurations, display screens, and names indicated in the embodiment stated above are merely examples, and different device configurations, display screens, and names may be used if needed.

For example, a task vehicle provided with the functional units 38 and 48 of the task vehicles 30 and 40 can be adopted as a task vehicle capable of cleaning waste and picking up/delivering packages. Further, an electric moving vehicle, such as an unmanned aerial vehicle or an automatic robot, capable of traveling with electric energy, may be used instead of the task vehicles 30 and 40, and the disclosure is not limited to a vehicle.

For example, in the embodiment, deep learning using a neural network is referred to as the example of machine learning, but machine learning based on other methods may be adopted. Other supervised learning, such as support vector machines, decision trees, naive Bayes, and k-nearest neighbors, may be used. Semi-supervised learning may be employed instead of supervised learning. Furthermore, reinforcement learning or deep reinforcement learning may be used as the machine learning.

Recording Medium

In one embodiment of the present disclosure, a program capable of executing the processing method by the area management server 10 and the task vehicles 30 and 40 may be recorded on a recording medium readable by a computer or another machine/device (hereinafter referred to as a computer). By causing the computer to read out and execute the program in the recording medium, the computer can serve as the control units of the area management server 10, and the task vehicle 30 and 40. The recording medium that can be read by the computer is a non-transitory recording medium that can store information such as data and programs by electrical, magnetic, optical, mechanical, or chemical methods and can be read from the computer. Among such recording media, those that can be removed from the computer include, for example, flexible discs, magneto-optical discs, CD-ROMs, CD-R/Ws, DVDs (digital versatile disks), BDs, DATs, magnetic tapes, and memory cards such as flash memories. Additionally, an example of a recording medium mounted on the computer includes a hard disk and a ROM. Further, SSD can be used as the recording medium that can be removed from the computer and as the recording medium that can be mounted on the computer.

### OTHER EMBODIMENTS

Moreover, for the area management server 10, the task vehicles 30 and 40, the waste disposal facility 60, and the package processing facility 70 according to the embodiment, the term “unit” can be interpreted as “circuit” or the like. For example, the communication unit can be understood as a communication circuit.

Furthermore, the program to be executed by the area management server 10 according to the embodiment may be stored on the computer connected to the network such as the Internet and provided by downloading via the network.

In the description of the flowchart in the present specification, the context of the relationship between steps has been clarified by using expressions such as “after”, “then”, and “subsequently”, but the order of steps for implementing the present embodiment is not uniquely defined by those expressions. In other words, the order of processes in the flowchart described in the present specification can be changed if no contradiction or conflict occurs.

Furthermore, edge computing may be adapted to shorten a time taken to execute an arithmetic process and to communicate enormous amounts of data efficiently, in which terminals that can execute a partial process of the server are distributed and arranged at a location physically close to the information processing device, instead of the system with a single server.

Further advantageous effects and modifications can be easily appreciated by those skilled in the art. The aspects of the present disclosure are not limited to the specific details and representative embodiments illustrated and described above. Accordingly, various modifications may be made without departing from the spirit or scope of the general inventive concept as defined by the following claims and their equivalents.

What is claimed is:

1. An information processing device, comprising:
a processor having hardware, wherein the processor is configured to:
create, upon acquiring a charging signal indicating that an electric moving vehicle autonomously moving by power stored in a battery requires charging of the battery, or determining that the charging is required, based on a predetermined task additionally set to the electric moving vehicle, schedule information including a travel schedule that enables the electric moving vehicle to travel to a charging station where the battery is to be charged and to perform the task; and
output the schedule information to the electric moving vehicle.

2. The information processing device according to claim 1, wherein the processor is configured to, upon acquiring the charging signal or determining that the charging is required, output information on the task to the electric moving vehicle.

3. The information processing device according to claim 1, wherein the processor is configured to:
create, upon acquiring a completion signal indicating that the charging of the battery is completed in the electric moving vehicle, or determining that the charging of the battery is completed, based on a second task which is additionally set to the electric moving vehicle and is different from the task, second schedule information including a travel route that enables the electric moving vehicle to return to a predetermined location and to perform the second task; and
output the second schedule information to the electric moving vehicle.

4. The information processing device according to claim 3, wherein the second task includes delivery of a package to a predetermined location, and the processor is configured to output information on the second task to the electric moving vehicle.

5. The information processing device according to claim 1, wherein the task includes a collection of waste and transportation of the waste to a predetermined landfill site.

6. The information processing device according to claim 1, wherein the task includes receipt of a package and transportation of the package to a predetermined package handling center.

7. An information processing system comprising:
a first device which includes:
a task unit configured to execute a predetermined task that is additionally set;
a rechargeable battery; and
a first processor having hardware, the first processor being configured to acquire task information including information on the task and schedule information on traveling, and to output an instruction signal for autonomous travel based on the schedule information, and
a second device which includes:
a second processor having hardware, the second processor being configured to create, upon acquiring a charging signal indicating that the battery requires charging in the first device, or determining that the charging is required, based on the task preset by the task unit, the schedule information including a travel schedule that enables the first device to travel to a charging station where the battery is to be charged and enables the task unit to perform the task, and output the schedule information to the first device.

8. The information processing system according to claim 7, wherein the second processor is configured to, upon acquiring the charging signal or determining that the charging is required, output information on the task to the first device.

9. The information processing system according to claim 7, wherein the second processor is configured to:
create, upon acquiring a completion signal indicating that the charging of the battery is completed in the electric moving vehicle, or determining that charging of the battery is completed, based on a second task which is additionally set to the task unit and is different from the task, second schedule information including a travel route that enables the first device to return to a predetermined location and enables the task unit to perform the second task; and
output the second schedule information to the first device.

10. The information processing system according to claim 9, wherein the second task includes delivery of a package to a predetermined location, and the second processor is configured to output information on the second task to the first device.

11. The information processing system according to claim 7, wherein the task includes a collection of waste and transportation of the waste to a predetermined landfill site.

12. The information processing system according to claim 11, wherein the first device is a task vehicle configured to travel autonomously and clean a predetermined area.

13. The information processing system according to claim 7, wherein the task includes receipt of a package and transportation of the package to a predetermined package handling center.

14. The information processing system according to claim 13, wherein the first device is a task vehicle configured to travel autonomously, receive a package from a facility in a predetermined area, and deliver the package to a facility in the predetermined area.

15. A program causing a processor having hardware to execute:
creating, upon acquiring a charging signal indicating that an electric moving vehicle autonomously moving by power stored in a battery requires charging of the battery, or determining that the charging is required, based on a predetermined task additionally set to the electric moving vehicle, schedule information including a travel schedule that enables the electric moving vehicle to travel to a charging station where the battery is to be charged and to perform the task; and
outputting the schedule information to the electric moving vehicle.

16. The program according to claim 15, wherein the program causes the processor to execute outputting information on the task to the electric moving vehicle upon acquiring the charging signal or determining the charging is required.

17. The program according to claim 15, wherein the program causes the processor to execute:
creating, upon acquiring a completion signal indicating that the charging of the battery is completed in the electric moving vehicle, or determining that the charging of the battery is completed, based on a second task which is additionally set to the electric moving vehicle and is different from the task, second schedule information including a travel route that enables the electric moving vehicle to return to a predetermined location and to perform the second task; and
outputting the second schedule information to the electric moving vehicle.

18. The program according to claim 17, wherein the second task includes delivery of a package to a predetermined location, and the program causes the processor to execute outputting information on the second task to the electric moving vehicle.

19. The program according to claim 15, wherein the task includes a collection of waste and transportation of the waste to a predetermined landfill site.

20. The program according to claim 15, wherein the task includes receipt of a package and transportation of the package to a predetermined package handling center.
